(19) United States
(12) Patent Application Publication
(10) Pub. No.: US 2012/0106344 A1
(43) Pub. Date: May 3, 2012

(54) DATA COMMUNICATION ACKNOWLEDGEMENT IN A NETWORK

(75) Inventors: Nikolaos Chrysos, (US); Cyriel J. Minkenberg, (US)

(73) Assignee: International Business Machines Corporation, Armonk, NY (US)

(21) Appl. No.: 13/279,254

(22) Filed: Oct. 22, 2011

(30) Foreign Application Priority Data
Oct. 28, 2010 (EP) 10189274.3

(51) Int. Cl. H04L 12/24

(52) U.S. Cl. 370/236

(57) ABSTRACT

A communication method for transmitting a data packet from a first node to a second node connected by an interconnection network. Steps performed include sending a data packet from the first node to the second node, sending an acknowledgment message from the second node to the first node within an acknowledgement generation delay period (Dack) upon reception of the data packet, determining at the first node whether no acknowledgment message is received during a time-out period (Tp), where the acknowledgement generation delay period (Dack) is related to the time-out period (Tp), and adapting the time-out period (Tp) depending on a network load indicating an amount of traffic over the connection between the first and the second node.

### CROSS-REFERENCE TO RELATED APPLICATIONS

This application claims priority under 35 U.S.C. §119 to European Patent Application No. 10189274.3 filed Oct. 28, 2010, the entire text of which is specifically incorporated by reference herein.

### BACKGROUND

The present invention relates to packet-based data communication, in particular to data communication wherein the reception of a data packet is acknowledged by a receiving node. Furthermore, the present invention relates to measures to speed-up data communication by increasing data reception acknowledging efficiency.

Interconnection networks, such as networks in data centers, high performance computing systems, or storage systems, have very demanding requirements regarding data transmission reliability since higher layers are usually very intolerant with respect to data packet losses. To increase reliability of packet reception end-to-end retransmission policies are usually applied such as sending back an acknowledgment message. Such an end-to-end reliable delivery function is usually implemented by hardware, i.e., in network adapters or router linecards.

With the miniaturization of IC technology the frequency of soft errors in data transmission increases and networks will have to deal with soft errors more frequently. In contrast to systems where transmission errors are merely exceptional cases data transmission performance is becoming more and more affected by the efficiency of error resolution routines. Furthermore, network consolidation, e.g. in the data center, eventually means that some applications which cannot afford data packet losses and which do not rely on reliable transmission protocols like TCP, may be using a general purpose lossy network with no internal flow control. In addition, some other networks may intentionally ignore flow control signals, in order to serve some quality-of-service purposes. All the above factors confirm the need for a fault tolerable network that recovers lost data packets.

Soft errors can be generally handled using link-layer coding techniques or link-level retransmissions. In systems with many switching nodes link-level retransmissions add significant cost and complexity and may even be infeasible for instance in all-optical networks where no buffering of data packets is possible. Implementing a retransmission protocol in the network nodes appears to be more flexible than implementing a retransmission protocol at every switching element.

According to known reliable delivery schemes, the source node keeps a copy of every data packet it transmits over the network and waits for an acknowledgement that will confirm that the packet was properly received at a destination node. The acknowledgement is a message that is generated by the destination node when it receives a data packet. The acknowledgement message usually carries an identifier which may be the packet's sequence number that allows the source node to determine which data packet a received acknowledgement message refers to. Error recognition using check sum methods or the like can be implemented so that the acknowledgement message is generated only in case the received data packet has no detectable error. If the acknowledgement message does not arrive at the source node in a predefined amount of time (time-out period) a timer in the source node expires and the data packet is retransmitted over the network repeating the same steps until proper receipt is confirmed.

In such a delivery scheme one acknowledgement message is generated and sent from destination node to source node for each payload data packet received at the destination node. These acknowledgement messages can increase the effective load of the network and can even double it, e.g. in synchronous slotted systems where the acknowledgement message size is necessarily equal to that of the payload data packets. In any case, the network transmission capacity must be over-dimensioned to carry the additional load provided by the acknowledgement messages. In case of synchronous slotted systems the network transmission capacity must be over-dimensioned by about two times in order to sustain the targeted payload data bandwidth. In other words if the peak bandwidth of payload data transfers is b, the network has to be designed for an aggregate bandwidth of up to 2*b in order to convey both payload data packets and acknowledgement messages. Even for traffic patterns where the payload data only use one third of the aggregate network bandwidth the acknowledgement messages may increase the network utilization, bringing the load to two thirds of bandwidth utilization. Overall, this increases contention inside the network and also delays transfer of the payload packets beyond what is expected.

To reduce the bandwidth overhead necessary to implement the above acknowledgement scheme it is common to increase the size of the payload packets for each acknowledgement message, e.g. a large RDMA (Remote Direct Memory Access) transfer, which may be transferred via multiple network packets. However, this solution may not bring the desired results when, for instance, the pieces of payload information to be communicated have a small size. It also means that when the transmission of one network packet fails the entire block of the network packets has to be retransmitted.

Another way to reduce the bandwidth overhead is to reduce the size of the acknowledgement messages. The actual size of an acknowledgement message is mainly determined by header bits, such as source node address, destination node address, CRC (check sum) etc. while the essential information of an acknowledgement message requires just a few identification bits that are needed to identify the acknowledged data packet. The identification bits may indicate a sequence or identification number of the payload data packet to be acknowledged. As the header bits and identification bits carry essential information for the acknowledgement, the acknowledgement data packet size cannot be made arbitrarily small, and so the size of an acknowledgement message cannot be reduced beneath a minimum size of a data packet. In synchronous slotted networks, for instance, the data packet size is equal for all messages so that each acknowledgement message will have the same size as the payload packets.

The bandwidth overhead for acknowledgement messages can also be reduced by piggybacking acknowledgement messages on the payload data packets of the reverse connection, i.e. on other payload data packets transmitted from the destination node to the source node. When an acknowledgement message is piggybacked, the bandwidth overhead is reduced to just a few sequence number bits that are injected in the header of a payload data packet.

The efficiency of piggybacking depends on the presence of payload data at the destination node, targeting the source node at the specific time when the destination node receives a payload data packet from the source node. However, when network traffic is asymmetric or the load of the reverse connection is low, reverse data packets to be sent back to the source node may not be available at the time that the destination node needs them to acknowledge the receipt of the payload. In this case, standalone acknowledgement messages must be sent back to the source node.

This issue is partially overcome through deferred acknowledgement messages as disclosed in A. Tanenbaum, Computer Networks, Prentice Hall, Inc., 1998. Therein, it is proposed that the destination node can safely defer the injection of a standalone acknowledgement message (acknowledgement message not attached to a reverse payload data packet) for a period of time that is a function of the time-out period at the source node. When the destination node receives a data packet at time t, it can maximally defer sending an acknowledgement message for an acknowledgement generation delay of Dack=Tp−2*Dnet, wherein Tp corresponds to the time-out period and Dnet the packet delay in the network when sending a data packet from the source node to the destination node and vice versa.

If a reverse data packet appears at the destination node in the time interval that the destination is allowed to wait, i.e. within [t, t+Tp−2*Dnet], the acknowledgement message will be piggybacked onto the respective reverse data packet. Otherwise, if piggybacking is not possible because a reverse data packet did not appear within the time interval at the destination node, a standalone acknowledgement message is issued at time t+Tp−2×Dnet.

Deferred acknowledgement messages however do not take into account the actual load of the reverse connections in irregular traffic patterns. For instance, if the destination node injects a payload data packet towards the source node every 10 ms while the time-out period is only 1 ms, the destination node will have to inject a standalone acknowledgement message most of the time.

As another solution the destination node may send cumulative or aggregated acknowledgement messages. In this case, a single acknowledgement message confirms the proper receipt of multiple packets either explicitly by conveying e.g. multiple sequence numbers to the source, or implicitly if the acknowledgement message carries the sequence number of the last in-order packet properly received at the destination node. Such cumulative acknowledgement messages improve fault-tolerance by recovering acknowledgement messages that were lost in the network.

### BRIEF SUMMARY

An embodiment of the present invention provides a communication method and devices that allow reducing the bandwidth overhead from retransmitting acknowledgement messages back to a source node while still assuring reliability of the data transmission. This objective is solved by the communication methods according to claims herein and the further communication methods, the network system and the nodes according to the further claims.

According to a first aspect, a communication method for transmitting a data packet from a first node to a second node connected by means of an interconnection network is provided. The communication method comprises the steps of sending a data packet from a first node to a second node; sending an acknowledgment message from the second node to the first node within an acknowledgement generation delay period upon reception of the data packet; determining at the first node whether no acknowledgment message is received during a time-out period, wherein the acknowledgement generation delay period is related to the time-out period; and adapting the time-out period depending on a network load indicating an amount of traffic over the connection between the first and the second node.

One idea of the above method is to use a deferred acknowledgement messaging scheme. In a deferred acknowledgement messaging scheme, a second (destination) node is allowed to wait sending an acknowledgement message to a first (source) node during an acknowledgement generation delay period before the acknowledgement message is actually sent out. So the destination node can increase likelihood of, e.g., an availability to piggyback the acknowledgement message onto another data packet sent from the destination node to the source node. Thereby, network bandwidth can be saved by piggybacking the acknowledgement message onto the payload data packets. The acknowledgement generation delay period is related to the time-out period so that an acknowledgement message sent at the end of the acknowledgement generation delay period starting at the arrival of the data packet at the destination node, arrives at the end of time-out period at the source node.

In general deferred acknowledgement messages aim to decrease network overhead by increasing the likelihood of piggybacking acknowledgement messages on reverse payload data that are transmitted in the reverse direction, i.e. from the destination node to the source node. This means that the longer the time-out period of the source node and so the acknowledgement generation delay period of the destination node is the bigger the likelihood that an acknowledgement message can be piggybacked onto a reverse payload packet. As a consequence an increase in the time-out period of the source node will decrease the acknowledgement bandwidth overhead needed. However, the time-out period cannot be arbitrarily increased, as larger time-out periods require larger buffers at the source and destination nodes and also increase the delay in discovering and recovering from packet losses. This delay is significant for many applications and, in particular, in inter-processor communication applications.

Hence the above method proposes to dynamically adapt the time-out period on a per connection basis in response to the dynamic load of the payload packets in the reverse connection. This allows for a discriminative adjustment of the time-out period, on a per-connection basis, and a flexible balance of the afore-mentioned trade-off. According to the above method the time-out period in the source node can be e.g. dynamically increased over the set of connections that have lightly loaded reverse traffic while other connections can be operated with a smaller time-out period thus having a smaller packet recovery time and eliminating the need for large buffers.

Furthermore, the first node may resend the data packet if it is determined that no acknowledgment message is received at the first node during the time-out period.

According to a further embodiment, the second node may adapt the acknowledgement generation delay period as a function of the load of the network. The step of sending the acknowledgment message from the second node to the first node within the acknowledgement generation delay period upon reception of the data packet further may comprise the further steps of attaching or embedding the acknowledgement message to a reverse data packet waiting for being transmitted from the second node to the first node; and if no reverse data packet to be transmitted from the second node to the first node is available during the acknowledgement generation delay period, sending the acknowledgement message in its data packet from the second node to the first node.

It may be provided that the network load is estimated based on measuring the inter-arrival times of data packets at the second node targeting the first node, wherein the inter-arrival times of the data packets is related to the frequency of data packets to be sent from the second node to the first node. Moreover, the estimation of the network load may include a calculation of exponential moving averages to obtain a mean inter-arrival time.

The second node may set the value of said maximum acknowledgement generation delay period as a product of the mean inter-arrival time and a predetermined positive real number A.

Furthermore, the time-out period may be set as the sum of a product of the mean inter-arrival time and a predetermined positive real number A and the double packet transmission time which is the time needed for transmitting a packet from the first node to the second node.

The step of estimating of the network load may be performed by the second node, wherein the second node communicates the estimated network load to the first node.

In particular, the step of estimating of the network load may be performed by the first node, wherein the first node communicates to the second node the estimated network load.

According to a further embodiment, the time-out period in the first node may be initially set to a predetermined minimum value.

The time-out period may be limited to a predetermined minimum time-out period and/or to a predetermined maximum time-out period.

The acknowledgement generation delay period may be further limited to a predetermined minimum value of the acknowledgement generation delay and/or to a predetermined maximum value of the acknowledgement generation delay.

It may be provided that the minimum time-out period and said maximum time-out period, and/or the minimum value of the acknowledgement generation delay and the maximum value of the acknowledgement generation delay, are defined separately for each connection of the first node or of the second node, respectively.

According to a further aspect, a communication method for transmitting a data packet via a data connection of an interconnection network is provided. The method includes the steps of sending a data packet over the interconnection network; awaiting an acknowledgment message within a time-out period after sending the data packet; determining whether no acknowledgment message is received during the time-out period; and adapting the time-out period depending on a network load indicating an amount of traffic over the data connection.

According to a further aspect, a communication method for receiving a data packet via a data connection of an interconnection network is disclosed. The method comprising the steps of receiving a data packet; sending an acknowledgment message within an acknowledgement generation delay period upon reception of the data packet; adapting the acknowledgement generation delay period depending on a network load indicating an amount of traffic over the data connection.

According to a further aspect, a communication system for transmitting a data packet from a first node to a second node connected by means of a data connection of an interconnection network is provided. The system includes a first node adapted to send a data packet to a second node. The second node is adapted to send an acknowledgment message to the first node within an acknowledgement generation delay period upon reception of the data packet. The first node is adapted to determine whether no acknowledgment message is received during a time-out period. Moreover, the first node is adapted to set the time-out period depending on a network load of the network indicating an amount of traffic over the connection between the first and the second node.

According to a further aspect, a communication node for transmitting a data packet via a data connection of an interconnection network is provided. The communication node includes a control unit and a timer. The control unit is adapted to send a data packet over the interconnection network, await an acknowledgment message within a time-out period after sending the data packet, and determine whether no acknowledgment message is received during the time-out period. The timer adapts the time-out period depending on a network load indicating an amount of traffic over the data connection.

According to a further aspect, a communication node for receiving a data packet via a data connection of an interconnection network is provided. The communication node includes means for receiving a data packet, means for sending an acknowledgment message within an acknowledgement generation delay period upon reception of the data packet, and means for adapting the acknowledgement generation delay period depending on a network load indicating an amount of traffic over the data connection.

According to a further aspect, a computer program product comprising software code portions loadable into an internal memory of a data processing unit, wherein, when the software code portions are executed on the data processing unit, the above method steps are performed.

### BRIEF DESCRIPTION OF THE DRAWINGS

Preferred embodiments of the present inventions are described in detail in the following description in conjunction with the accompanying drawings in which:

FIG. 1 schematically shows a network system having communicating nodes;

FIG. 2 a diagram illustrates the maximum acknowledgement message generation delay depending on the time-out period of a source node; and

FIG. 3 shows a flow diagram illustrating the method step for a communication method having a reduced acknowledgement bandwidth overhead.

### DETAILED DESCRIPTION

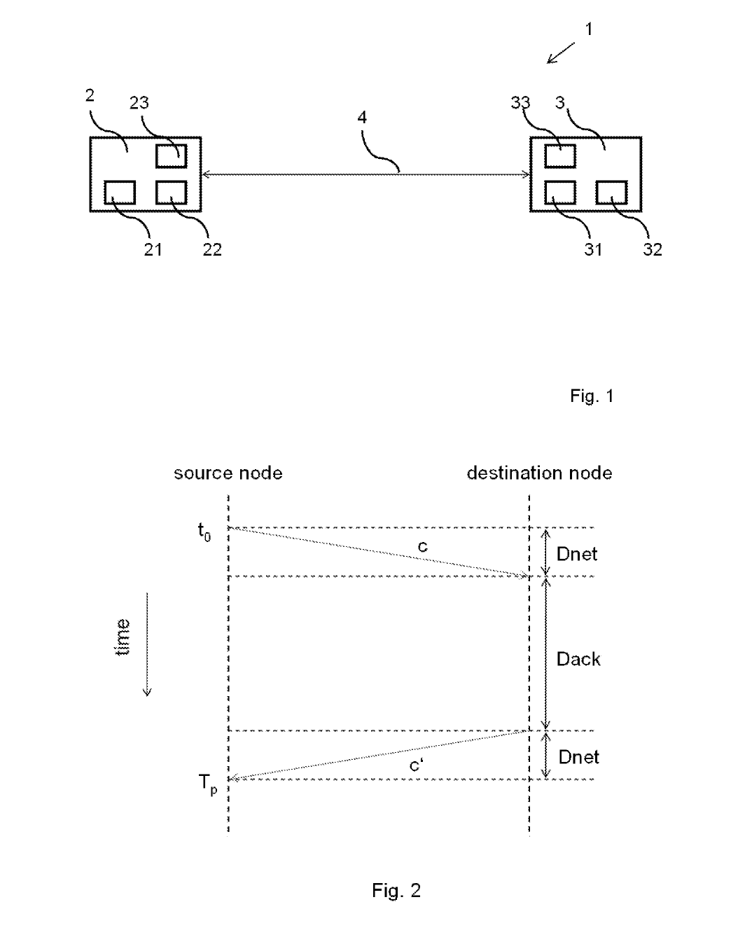

FIG. 1 schematically shows a network system 1 having two nodes: a first node 2 and a second node 3 which are interconnected with each over a network connection 4. The network nodes 2, 3 and the network connection 4 are adapted to allow a packet-based data communication wherein payload data is transmitted in a packet-based manner from a source node to a destination node. In the following description the first node corresponds to a source node from which a data packet is to be sent and the second node corresponds to a destination node where the data packet is to be received.

The first and second nodes 2, 3 include control units 21, 31 to control operation of the respective nodes including a communication method as described below. Furthermore, the nodes 2, 3 include input and output queues 22, 32 which buffer data packets for sending and receiving, respectively.

To assure reliability of transmitting data in such a network an acknowledgement messaging scheme is provided. Accordingly, after reception of a data packet at destination node 3 originating from the source node 2 an acknowledgement message identifying the received data packet is sent back from the destination node 3 to the source node 2. The identifying can be performed by associating a sequence or identification number to each sent data packet and/or including or embedding it to the data packet. The acknowledgement message referring to the respective data packet just contains the associated sequence or identification number. A copy of the sent data packet is maintained in source node 2 as long as the acknowledgement message referring to the payload data packet has not yet been received. Once the acknowledgement message has been received the sequence or identification number is read out and a proper transmission of the data packet associated with the respective sequence or identification number is confirmed.

The control unit 21 of source node 2 constantly checks for each sent data packet to determine whether an acknowledgement message has been received within a given time-out period. The source node 2 has implemented a timer 23 to detect a time-out according to this given time-out period Tp. If a time-out is detected, i.e. an acknowledgement message has not been received within a specific time period after the data packet has been sent out by source node 2, the data packet still maintained in the output queue 22 is resent. This procedure is repeated as long as no acknowledgement message has been received. When the acknowledgement message has been received within the time-out period Tp, the original data packet can be deleted from the output queue 22 of source node 2.

The time-out period Tp is usually customized to accommodate a given acknowledgement bandwidth overhead along with the buffer sizes of the source and destination nodes and a maximally acceptable delay for discovery of a data packet loss. According to the proposed communication protocol the time-out period for the reception of acknowledgement messages in the source node 2 regarding a specific connection between a specific source node 2 to a specific destination node 3 is adapted in response to an indication of a network load, e.g. a load/frequency of data packets to be sent back from the destination node 3 to the source node 2.

In FIG. 2 a time diagram is shown, illustrating a communication method between the source node 2 and the destination node 3. Further FIG. 2 shows the duration of an acknowledgement generation delay Dack which corresponds to a maximum waiting time at the destination node 3. The acknowledgement generation delay Dack corresponds to a maximum waiting time for incoming reverse data packets to be forwarded to the source node 2. The acknowledgement generation delay Dack depends on the time-out period Tp set in a source node 2. In FIG. 2 at time t0 a payload data packet p is sent from the source node 2 to the destination node 3, and it arrives there within a network delay Dnet. The network delay Dnet corresponds to the time a data packet needs to travel from the source node 2 to destination node 3 or vice versa.

The destination node 3 comprises a timer 33 to measure the acknowledgement generation delay period Dack. A respective timer 33 is started each time a data packet from the source node 2 arrives. Within the acknowledgement generation delay time Dack an acknowledgement message is to be sent back to the source node 2 from the destination node 3 such that it arrives there within the time-out period Tp of the source node 2. Since it can be assumed that the network delay Dnet for transmitting a data packet from the source node 2 to the destination node 3 and from the destination node 3 to the source node 2 is substantially equal the acknowledgement generation delay Dack can be defined as: Dack=Tp−2*Dnet.

This ensures that the source node 2 will receive the acknowledgement message before the respective time-out timer in the source node 2 expires.

To reduce the bandwidth requirement necessary for retransmitting acknowledgement messages, the acknowledgement messages are preferably attached to or piggybacked onto other (reverse) payload data packets sent back from the destination node 3 to the source node 2. However, since the data traffic in such networks is usually asymmetric the availability of a reverse payload data packet at the destination node 3 to be sent to the source node 2 is not ensured and the availability of reverse payload packet substantially depends on the duration of acknowledgement generation delay Dack allowed for the specific data connection. In other words, when a reverse payload packet is waiting or available to be sent from the destination node 3 to the source node 2 during a time period beginning with the time of reception of a payload data packet at the destination node 3 and having a duration of the acknowledgement generation delay, the acknowledgement message can be attached to or embedded in the reverse payload packet thereby not noticeably contributing to the network load. In the case where no reverse payload data packet is present or arrives at the destination node 3 within the acknowledgement generation delay period, the acknowledgement message will be sent in a standalone data packet not carrying any additional payload to the source node 2 thereby substantially increasing the network traffic.

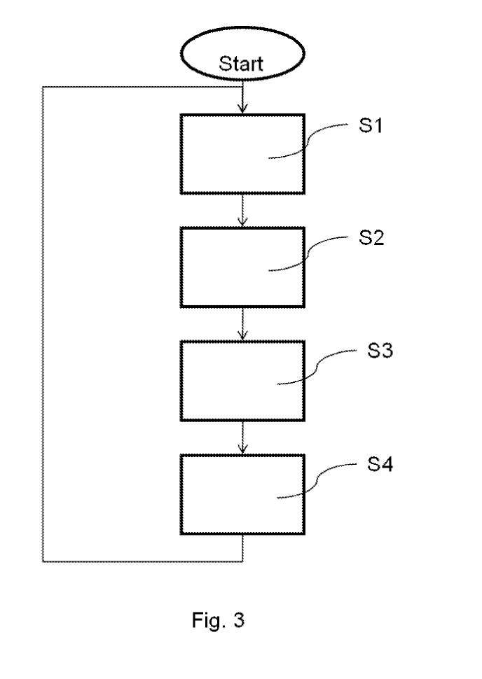

According to one embodiment of the present invention which is illustrated in the flow diagram of FIG. 3 a method for adapting a time-out period Tp belonging to the specific connection c from a given source node 2 to a given destination node 3 is provided. Accordingly, the time-out period Tp is updated in response to an indication about the network load.

In a step S1 after starting the method for adapting the time-out period Tp the time-out period Tp is initially set up e.g. after power-up of the respective source node 2. For each connection c there is preset a maximum retransmission time-out period MaxTO(c) and a minimum retransmission time-out period MinTO(c). As an initial state the source node 2 and in case of a plurality of source nodes 2, the source nodes 2 can be preset with a time-out period Tp equal to the minimum time-out period MinTO(c). Since the acknowledgement generation delay period Dack of the destination node 3 relates to the time-out period Tp of the source node 2, also the acknowledgement generation delay period Dack is set to a minimum acknowledgement generation delay Dack_min. The minimum acknowledgement generation delay Dack_min can be preset in the respective destination node 3 or calculated from the preset minimum retransmission time-out period MinTO(c) either in the source node and then transmitted to the destination node 3 or directly in the destination node 3.

In step S2 a network load is measured. The measuring of the network load can be performed in the destination node 3 or the source node 2. The network load can be indicated e.g. by a mean inter-arrival time MIAT(c′) of data packets at the destination node 3. An inter-arrival time corresponds to the time period between the arrivals of data packets at the destination node 3 to be forwarded to the source node 2 in a reverse connection c′ having as its source the destination node 3 of connection c and as its destination the source node 2 of connection c. For more than one reverse connection c′ from the respective destination node 3 to a plurality of source nodes 2 the time-out periods of which shall be adapted according to the presented retransmission scheme, the inter-arrival times are averaged to obtain a mean inter-arrival time MIAT. The destination node 3 may estimate the mean packet inter-arrival time MIAT(c′) of all connection c′ that ends at the present node which corresponds to the reverse connections c′ of connections c the time-out period Tp of which shall be adjusted.

Alternatively, instead of using the mean inter-arrival time MIAT(c′) of the reverse connection as an indication of the network load, a mean inter-departure time (MIDT) of data packets of the reverse connection could be used to estimate the load. An inter-departure time of the reverse connection corresponds to the time period between the departures of data packets at the destination node 3 to be forwarded to the source node 2 in the reverse connection c′.

In step S3 the time-out period Tp of each connection c is updated using a respective current mean packet inter-arrival time MIATcur(c′). Preferably, the updating of the time-out period Tp is performed in the source node 2 of the respective connection c after transmitting an information about the current mean packet inter-arrival time MIATcur(c′) to the source node 2 e.g. by attaching it onto a reverse payload data packet or sending it as a standalone data packet. Of course, it can be provided that the time-out period Tp is calculated in the destination node 3 and thereafter transmitted to the source node 2. In the source node 2 the timer 23 is set according to the currently calculated time-out period Tp.

The updating of the time-out period Tp in step S3 can be performed by using a customizable real number parameter A that allows setting the acknowledgement generation delay period Dack at the destination node 3 to a value that is several times larger than the current mean inter-arrival time MIAT. The value of parameter A specifies the possibility that piggybacking of the acknowledgement message information will fail. The larger A is the more likely is that the acknowledgement message will be piggybacked. Depending on the value of the current mean inter-arrival time MIATcur for the reverse connection c′ multiplied by the parameter A the time-out period Tp is calculated as follows: Tp=A*MIAT(c′)+2*Dnet.

However, the calculated time-out period Tp may be limited by the given minimum time-out period MinTO(c) and the maximum time-out period MaxTO(c).

The determination of the network load of the data connection wherein data packets being sent from the destination node 3 to the source node 2 can also be carried out by the source node 2. In case the source node 2 is designated to estimate the load of the data packets being sent from the destination source 3 to the source node 2 the source node 2 communicates to the destination source 3 the estimated load of data packets being sent from the destination node 3 to the source node 2.

In step S4 the new time-out period Tp may be used to compute a new acknowledgement generation delay period Dack for connection c according to Dack=Tp−2*Dnet, wherein Dnet is an estimation of the maximum delay that packets experience inside the network when travelling from the source node 2 to the destination n node 3 or vice versa. The computed acknowledgement generation delay period Dack is then updated in the destination node 3 such that the timer 33 can be set up accordingly every time a payload data packet arrives.

As described above for the time-out period Tp, the calculated acknowledgement generation delay period Dack may be limited by the given minimum acknowledgement generation delay period Dack_min and the maximum acknowledgement generation delay period Dack_max, wherein the minimum acknowledgement generation delay period Dack_min and the maximum acknowledgement generation delay period Dack_max are related to the minimum time-out period MinTO(c) and the maximum time-out period MaxTO(c).

Alternatively, after determining the current mean inter-arrival time MIATcur firstly the acknowledgement generation delay period Dack can be calculated as A*MIAT(c′) and in a next step time out period Tp can be calculated either in the destination node 3 or in the source node 2 of the connection c based on the current mean inter-arrival time MIATcur or on the acknowledgement generation delay period Dack.

Substantially, the calculation of the time-out period Tp, the current mean inter-arrival time MIATcur(c′), and the acknowledgement generation delay period Dack can be performed in any of the nodes 2, 3 of the respective connection c as long as the source node 2 is set up with the updated time-out period Tp and the destination node 3 is set up with the updated acknowledgement generation delay period Dack at a time.

For the estimation of the current mean inter-arrival time MIATcur(c′) of step S2, it may be provided that the control unit 31 of the destination node 3 maintains the time t1 that a data packet of the reverse connection c′ last arrived at the destination node 3. At time slot t when a new data packet of this reverse connection c′ arrives a method of exponential moving averages EMA can be used to obtain a new estimation for the current mean inter-arrival time MIATcur(c′) as

MIATcur(c′,t)=b×(t−t1)+(1−b)×MIATcur(c′,t1),

where parameter b is a real number in [0, 1] and in EMA systems a higher b value tends to discount older observations faster.

If a reverse connection c′ suddenly becomes inactive the mean inter-arrival time MIAT (c′) may retain an inaccurately small value. Therefore, if before updating the time-out period Tp at time slot t, the control unit 31 of the destination node 3 finds that t−t1>K×MIAT, where K is another preset positive integer constant parameter, it first resets MIAT (c′) setting to equal to MaxTO (c)/A.

The disclosed methods of the present invention may be implemented by software, hardware or a combination thereof. The hardware part can be implemented by using a special logic, and the software part can be stored in a memory and executed by an appropriate instruction execution system, such as a microprocessor, a personal computer (PC) or a mainframe.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadcast interpretation so as to encompass all such modifications and equivalent structures and functions.

That which is claimed is:

1. A communication method for transmitting a data packet from a first node to a second node connected by means of an interconnection network, comprising the steps of:
sending a data packet from a first node to a second node;
sending an acknowledgment message from the second node to the first node within an acknowledgement generation delay period (Dack) upon reception of the data packet;
determining at the first node whether no acknowledgment message is received during a time-out period (Tp), wherein the acknowledgement generation delay period (Dack) is related to the time-out period (Tp); and
adapting the time-out period (Tp) depending on a network load indicating an amount of traffic over the connection between the first and the second node.

2. The communication method according to claim 1, wherein the second node adapts the acknowledgement generation delay period (Dack) as a function of the load of the network.

3. The communication method according to claim 1, wherein the step of sending the acknowledgment message from the second node to the first node within the acknowledgement generation delay period upon reception of the data packet further comprises:
attaching or embedding the acknowledgement message to a reverse data packet waiting for being transmitted from the second node to the first node; and
sending the acknowledgement message in its data packet from the second node to the first node if no reverse data packet to be transmitted from the second node to the first node is available during the acknowledgement generation delay period (Dack).

4. The communication method according to claim 1, wherein the network load is estimated based on measuring the inter-arrival times of data packets at the second node targeting the first node, wherein the inter-arrival times of the data packets is related to the frequency of data packets to be sent from the second node to the first node.

5. The method according to claim 4, wherein the second node sets the value of said maximum acknowledgement generation delay period (Dack_max) as a product of the mean inter-arrival time (MIAT) and a predetermined positive real number A.

6. The method according to claim 4, wherein the time-out period (Tp) is set as the sum of a product of the mean inter-arrival time (MIAT) and a predetermined positive real number (A) and the double packet transmission time which is the time needed for transmitting a packet from the first node to the second node.

7. The method according to claim 4, wherein the step of estimating of the network load is performed by the second node, wherein the second node communicates the estimated network load to the first node, and/or by the first node, wherein the first node communicates to the second node the estimated network load.

8. The method according to claim 1, wherein the time-out period (Tp) is limited to a predetermined minimum time-out period (MinTO(c)) and/or to a predetermined maximum time-out period (MaxTO(c)), and/or wherein the acknowledgement generation delay period (Dack) is limited to a predetermined minimum value of the acknowledgement generation delay (Dack_min) and/or to a predetermined maximum value (Dack_max) of the acknowledgement generation delay.

9. A method according to claim 8, wherein the minimum time-out period (Tp) and the maximum time-out period (MaxTO(c)), and/or the minimum value of the acknowledgement generation delay (Dack_min) and the maximum value of the acknowledgement generation delay (Dack_max), are defined separately for each connection of the first node or of the second node, respectively.

10. A computer program product comprising software code portions loadable into an internal memory of a data processing unit, wherein, when the software code portions are executed on the data processing unit, the steps of claim 1 are performed.

11. A communication method for transmitting a data packet via a data connection of an interconnection network, comprising the steps of:
sending a data packet over the interconnection network;
awaiting an acknowledgment message within a time-out period (Tp) after sending the data packet;
determining whether no acknowledgment message is received during the time-out period (Tp); and
adapting the time-out period (Tp) depending on a network load indicating an amount of traffic over the data connection.

12. A communication method for receiving a data packet via a data connection of an interconnection network, comprising the steps of:
receiving a data packet;
sending an acknowledgment message within an acknowledgement generation delay period upon reception of the data packet; and
adapting the acknowledgement generation delay period depending on a network load indicating an amount of traffic over the data connection.

13. A communication system for transmitting a data packet from a first node to a second node connected by means of a data connection of an interconnection network, comprising:
a first node being adapted to send a data packet to a second node;
the second node being adapted to send an acknowledgment message to the first node within an acknowledgement generation delay period upon reception of the data packet; and
the first node being adapted to determine whether no acknowledgment message is received during a time-out period (Tp); and
wherein the first node is adapted to set the time-out period depending on a network load of the network indicating an amount of traffic over the connection between the first and the second node.

14. A communication node for transmitting a data packet via a data connection of an interconnection network, comprising:
a control unit adapted to:
send of a data packet over the interconnection network;
await an acknowledgment message within a time-out period after sending the data packet; and
determine whether no acknowledgment message is received during the time-out period; and
a timer adapted to adjust the time-out period depending on a network load indicating an amount of traffic over the data connection.

15. A communication node for receiving a data packet via a data connection of an interconnection network, comprising:
means for receiving a data packet;
means for sending an acknowledgment message within an acknowledgement generation delay period upon reception of the data packet; and
means for adapting the acknowledgement generation delay period (Dack) depending on a network load indicating an amount of traffic over the data connection.
